(19) United States
(12) Patent Application Publication
(10) Pub. No.: US 2010/0075167 A1
(43) Pub. Date: Mar. 25, 2010

(54) COMPOSITIONS FOR THE MANUFACTURE OF GYPSUM BOARDS, METHODS OF MANUFACTURE THEREOF, AND GYPSUM BOARDS FORMED THEREFROM

(75) Inventors: Stuart Brandon Gilley, Atlanta, GA (US); Hubert C. Francis, Lithonia, GA (US); Carla Greaves Jones, Stone Mountain, GA (US); Fabio E. Esguerra, Covington, GA (US)

Correspondence Address: Georgia-Pacific LLC, 133 Peachtree Street NE - GA030-41, ATLANTA, GA, 30303, US

(73) Assignee: Georgia-Pacific Gypsum LLC, Atlanta, GA (US)

(21) Appl. No.: 12/236,991

(22) Filed: Sep. 24, 2008

(51) Int. Cl. B32B 13/00; C04B 7/02

(52) U.S. Cl. 428/532; 106/730; 156/275.5

(57) ABSTRACT

A composition for the manufacture of a gypsum board comprising hydrated pregelatinized starch and stucco with 0.4 to 3 wt. % of starch based on the stucco weight is disclosed. The composition provides enhanced strength in the absence of other strengthening agents.

### BACKGROUND OF THE INVENTION

This disclosure relates to compositions for the manufacture of gypsum boards used in building construction, and the gypsum boards manufactured therefrom. In particular, additives for enhancing the strength of gypsum boards are disclosed. Also disclosed are methods for the manufacture of gypsum boards using the compositions.

Gypsum boards have been used extensively in the construction of both residential and commercial buildings. A typical gypsum board comprises a gypsum core disposed between two sheets of a heavy paper (e.g., multi-ply paper) or cardboard material, known as facing layers. The conventional manufacturing of gypsum board for use in wall and roofing materials is well known and generally involves forming a core layer of wet slurry between the two layers of facing paper. When the wet core sets and is dried, a strong, rigid, and fire-resistant building material results.

Extensive research and development have been directed to improving the mechanical properties of wallboard. Nonetheless, there remains a perceived need in the art for improved compositions and methods for the manufacture of gypsum wall board, particularly compositions and methods that will provide improved strength that permit gypsum to withstand the forces encountered during manufacture, transport, installation, and use. Another perceived need is to further improve the bonding of the gypsum core to the facing layer(s)

### SUMMARY OF THE INVENTION

In one embodiment, a composition for the manufacture of a gypsum board comprising a hydrated blend of pregelatinized starch and stucco with 0.4 to 3 wt. % of starch based on the stucco weight is disclosed. The blend provides enhanced strength in the absence of other strengthening agents.

In another embodiment, a water slurry for the manufacture of a gypsum board comprising pregelatinized starch and stucco with 0.4 to 3 wt. % of starch based on the stucco weight is disclosed. The slurry used to form the gypsum has a water demand, or water:stucco ratio of 0.7:1 to 1.1:1 by weight.

A method for making a gypsum board, the method comprising: forming a slurry from a dry blend of a pregelatinized starch and stucco; applying the slurry to a lower facing sheet to form a core layer; applying an upper facing sheet to the upper surface of the gypsum slurry to form a “sandwich” of slurry and lower and upper facing sheets; and heating the core layer and the upper or lower facing sheet sufficiently to dry the core layer to form the gypsum board.

A gypsum board made by the foregoing method is also disclosed.

In still another embodiment, a gypsum board comprising a gypsum core that is faced on one or both faces with a facing, wherein the gypsum core comprises the setting product of a slurry of a hydrated blend of pregelatinized starch and stucco with 0.4 to 3 wt. % of starch based on the stucco weight is disclosed. The slurry has a water demand, or water:stucco ratio of 0.7:1 to 1.1:1 by weight.

These and other embodiments are described in further detail below.

### BRIEF DESCRIPTION OF THE DRAWINGS

FIG. 1 is a schematic depiction of a process of producing a gypsum board.

### DETAILED DESCRIPTION OF THE INVENTION

It has unexpectedly been found by the inventors hereof that gypsum boards with improved nail pull resistance, compressive strength, and bonding are obtained by the addition of a dry pregelatinized starch to dry stucco. Stucco is herein defined as calcined gypsum, i.e. calcium sulfate hemihydrate or calcium sulfate anhydrite. It is particularly surprising that superior results are obtained when the pregelatinized starch is not first mixed with water, but rather combined with the stucco in a dry state. In a further advantageous feature, the dry pregelatinized starch can be used in the absence of other known additives such as strength-enhancing additives. Advantageously, the dry pregelatinized starch additives that are employed are inexpensive, readily available, and highly effective.

The core of the gypsum board is manufactured from a gypsum composition comprising gypsum, pregelatinized starch, and optionally other additives as are known in the art.

A variety of different gypsums can be used in the core of the boards, including the natural mineral that is extracted from quarries, or synthetic gypsum, known as desulfogypsum, that is produced from the desulfurization of electrical power plant flue gas effluents. Combinations of natural and synthetic gypsum can be employed. Whether natural rock or synthetic, the gypsum is typically dried, ground, calcined, and stored as stucco, which is calcium sulfate hemihydrate (CaSO₄.½H₂O). Stucco is a very dry powder that when mixed with water, re-hydrates over time and hardens into calcium sulfate dihydrate (CaSO₄.2H₂O), or the relatively hard mineral known as gypsum. This mineral typically accounts for more than 85% by weight of the gypsum core.

In one embodiment, the dry pregelatinized starch, in particular a dry hydroxyalkylated pregelatinized starch, is added to the dry stucco prior to hydrating the stucco. Starch (CAS# 9005-25-8, chemical formula (C₆H₁₀O₆)ₙ), is a polysaccharide carbohydrate comprising a large number of glucose monosaccharide units joined together by glycosidic bonds. Starch is predominantly present in plants and seeds as as amylose and amylopectin. Depending on the plant, starch generally contains 20 to 25 percent amylose and 75 to 80 percent amylopectin. Polysaccharide starches include maize or corn, waxy maize, potato, cassava, tapioca and wheat starch. Other starches include varieties of rice, waxy rice, pea, sago, oat, barley, rye, amaranth, sweet potato, and hybrid starches available from conventional plant breeding, e.g., hybrid high amylose starches having amylose content of 40% or more, such as high amylose corn starch. Also useful are genetically engineered starches such as high amylose potato and waxy potato starches.

The starches are pregelatinized. “Pregelatinized starch,” which is also termed cold-swelling starch, has been chemically and/or mechanically processed to rupture all or part of the starch granules. In contrast to native starch, pregelatinized starch can be soluble in cold water, or can form dispersions, pastes, or gels with cold water, depending on the concentration of the pregelatinized starch used and on the type of starch used to produce the pregelatinized starch. In principle it is possible to produce pregelatinized starch by various processes, for example by wet-thermal digestion using a roller dryer, mechanical, and thermal treatment with an extruder, or exclusively mechanical treatment with a vibratory mill. In all processes the starch grain structure and the para-crystalline molecular organization is disrupted, and the starch is converted into an amorphous substance. In addition to pregelatinization, the starches can be further physically modified, e.g., by extrusion, spray drying, drum drying, and agglomeration.

The starches can be chemically modified or derivatized, such as by etherification, esterification, acid hydrolysis, dextrinization, crosslinking, cationization, heat-treatment or enzyme treatment (e.g., with alpha-amylase, beta-amylase, pullulanase, isoamylase, or glucoamylase). One exemplary starch is a hydroxyalkylated starch such as a hydroxypropylated or hydroxyethylated starch, and succinated starches such as octenylsuccinated or dodecylsuccinated starches. Low amylose starches can be used. As used herein, the term “low amylose” is intended to include starches containing less than 40% by weight amylose. One commercially available starch is hydroxypropylated starch available from National Starch and Chemical Company. Other commercially available types of starches are waxy starches, also available from National Starch and Chemical Company. As used herein, the term “waxy” is intended to include a starch containing at least 95% by weight amylopectin.

In a specific embodiment, the pregelatinized starch is a non-gelling starch, i.e., any native or modified starch having a modulus of less than 100 Pa at 10⁻¹ rad/s, at 25° C., and at 5% solids dissolved in water. Exemplary non-gelling starches include those that are stabilized, including hydroxyalkylated starches such as hydroxypropylated or hydroxyethylated starches, and acetylated starches. In another embodiment, non-gelling starches include dextrinized starches. In a further embodiment, non-gelling starches include modified waxy and modified high amylose starches. Non-limiting examples of highly converted starches are highly converted sago, highly converted tapioca, and highly converted corn starch. Converted starch is starch that has been changed to a lower molecular form through various modifications. Modifications to convert starch to lower molecular weight are well known in the art. In one embodiment, non-gelling starches have a low viscosity, with a water fluidity in the range of from 40 to 90. In another embodiment, the starches will have a water fluidity in the range of 65 to 85. Water fluidity is known in the art and, as used herein, is measured using a Thomas Rotational Shear-type Viscometer (commercially available from Arthur A. Thomas Co., Philadelphia, Pa.), standardized at 30° C. with a standard oil having a viscosity of 24.73 cps, which oil requires 23.12±0.05 sec for 100 revolutions. Accurate and reproducible measurements of water fluidity are obtained by determining the time which elapses for 100 revolutions at different solids levels depending on the starch's degree of conversion: as conversion increases, the viscosity decreases. The conversion may be by any method known in the art including oxidation, enzyme conversion, acid hydrolysis, heat, and/or acid dextrinization.

Thus, in one embodiment the pregelatinized starch comprises a pregelatinized starch that has been chemically modified with a mono-reactive moiety to a degree of substitution of at least 0.015. In a particular embodiment, the pregelatinized starch is selected from the group consisting of ether and ester derivatives of starch, such as hydroxypropyl, hydroxyethyl, succinate, and octenyl succinate starch. In one specific embodiment the starch is a hydroxypropylated potato starch having a degree of substitution of 0.015-0.30 and a molecular weight of 200,000-2,000,000. Another specific embodiment comprises hydroxyethylated dent corn starch having a degree of substitution of 0.015-0.3 and a molecular weight of 200,000-2,000,000. Another specific embodiment comprises hydroxypropylated high-amylose corn starch with a degree of substitution of 0.015-0.3 and a molecular weight of 200,000-2,000,000.

A variety of different types of pregelatinized starch are commercially available and can be used. An exemplary pregelatinized starch material is cold-water-soluble granular pregelatinized starch materials produced, for example, as described in U.S. Pat. No. 4,465,702 to Eastman et al. A pregelatinized corn starch of this type is available under the trade name MIRAGEL® 463, manufactured by the A. E. Staley Manufacturing Company, which thickens and sets to a gel using room temperature water. Other pregelatinized starches that can be used include Ultra Sperse® M, from National Starch and Chemical Company of Bridgewater, N.J.; pregelatinized waxy corn starch, available from National Starch and Chemical Company; and a pregelatinized, hydroxyethylated dent corn starch available under the trade name Staramic® 747, from A. E. Staley Mfg. Co. of Decatur, Ill.; and the hydroxyethylated dent corn starches available under the trade names ETHYLEX® 2005-2095 from Tate & Lyle, UK.

The relative amount of the pregelatinized starch and the stucco will vary, depending on the desired properties of the gypsum board, the type of pregelatinized starch and gypsum used, and the presence and amounts of other optional additives, and can be readily determined by one of ordinary skill in the art without undue experimentation using the guidelines herein. For example, the dry blend comprises from 0.4 to 3 weight percent (wt. %), specifically from 0.5 to 1 wt. %, and more specifically from 0.7 to 0.84 wt. % of pregelatinized starch, based on the stucco weight.

In one embodiment, it has been found that the gypsum core composition has improved strength in the absence of sodium trimetaphosphate. Accordingly, in this embodiment, the gypsum core composition consists essentially of gypsum, pregelatinized starch, in particular a hydroxyalkylated pregelatinized corn starch, and other additive(s) known in the art, such as dispersants (watering-reducing aids), foaming agents, set retarders, set accelerators, biocides (mold and mildew control agents), fillers, water resistance additives, fire retardants, and combinations comprising at least one of the foregoing. Other types of strength-enhancing agents can also be present, for example polymeric binders, but sodium trimetaphosphate is not present. Alternatively in this embodiment, the gypsum core composition consists of gypsum, starch, in particular pregelatinized starch, and an additive selected from dispersants (watering-reducing aids), foaming agents, set retarders, set accelerators, mold and mildew control agents, fillers, water resistance additives, strengthening agents except for sodium trimetaphosphate, and combinations comprising at least one of the foregoing.

In another embodiment, it has been found that the gypsum core composition has improved strength in the absence of any other strength-enhancing additives, such as sodium trimetaphosphate, polymeric binders, and others. Exemplary polymeric binders include acrylic latexes and other vinyl homopolymers and copolymers, including polyvinyl acetate and a copolymer of vinyl acetate with another vinyl monomer such as ethylene. In this embodiment, the gypsum core composition consists essentially of gypsum, pregelatinized starch, in particular a hydroxyalkylated pregelatinized corn starch, and other additive(s) known in the art, such as dispersants (watering-reducing aids), foaming agents, set retarders, set accelerators, biocides (mold and mildew control agents), fillers, water resistance additives, fire retardants, and combinations comprising at least one of the foregoing, and not enhancing-enhancing agents for example polymeric binders and sodium trimetaphosphate. Alternatively in this embodiment, the gypsum core composition consists of gypsum, starch, in particular pregelatinized starch, and additive(s) selected from dispersants (watering-reducing aids), foaming agents, set retarders, set accelerators, mold and mildew control agents, fillers, water resistance additives, and combinations comprising at least one of the foregoing, and not strengthen-enhancing agents (such as sodium trimetaphosphate or polymeric binders).

Exemplary dispersants (water reducing aid) include, for example, napthalene sulfonate. The dispersant, when present, can be used in an amount of 0.0001 to 1 wt. % based on the stucco weight in the composition, specifically 0.1 to 0.7 wt. %, and more specifically 0.1-0.4 wt. %.

Exemplary foaming agents include various soaps. The foaming agents, when present, can be used in an amount of 0.0001 to 1 wt. % based on the stucco weight in the composition.

A set retarder can be used to tailor the set time of the core composition. One class of set retarders agents that can be used comprises divalent or trivalent metal compounds, such as magnesium oxide, zinc oxide, calcium carbonate, magnesium carbonate, zinc sulfate, and zinc stearate. Set retarders, when present, typically are used at very low rates, for example at 0.0001 to 0.001 wt. % based on the stucco weight in the composition, more specifically at 0.0005 to 0.0008 wt. %,

Set accelerators include potassium sulfate and ammonium sulfate, aluminum sulfate, ball mill accelerator, and the like. The set accelerators, when present, can be used in an amount of 0.0001 to 1 wt. % based on the stucco weight in the composition.

Exemplary foaming agents include various soaps. The foaming agents, when present, can be used in an amount of 0.0001 to 1 wt. % based on the stucco weight in the composition.

Biocides, i.e. for mold and mildew resistance, can also be present in amounts known to be effective. Exemplary biocides include zinc thiocarbamates. The biocide, when present, can be used in an amount of 0.0001 to 1 wt. % based on the stucco weight in the composition.

Various fillers can be present, such as cenospheres (hollow ceramic microspheres), diatomite, wollastonite, ground rice hulls, ground perlite, chopped glass fibers, or the like, are particularly suitable for this purpose. These and other fillers may also be used to provide additional benefits. For example, calcium carbonates or alumina hydrates improve sandability and flexibility of the coated layer respectively. The acoustic/thermal insulation properties of the layer can be improved by including rubber particles, vermiculite, perlite, and shredded or expanded polystyrene. Fly ash, colloidal silica, fumed silica, and colloidal alumina, can also be used. Fly ash is defined as solid powders having a chemical composition similar to or the same as the composition of material that is produced during combustion of powdered coal, i.e., 25 to 60 wt. % silica, 10 to 30 wt. % Al₂O₃, 5 to 25 wt. % Fe₂O₃, 0 to 20 wt. % CaO and 0 to 5 wt. % MgO. Filler, when present, can be used in an amount of 5 to 30 wt. % based on the weight of the stucco in the composition, more specifically 10 to 25 wt. %, and most specifically 15 to 20 wt %.

Water resistance aids (hydrophobic agents) can be present, for example wax-asphalt emulsions, silicones, siloxanes, siliconates, and the like. Wax-asphalt emulsions, for example, are described in U.S. Pat. No. 5,791,109. These additives, when present, can be used in an amount of 0.3 to 10 wt. % of the slurry composition, based on the total weight of the stucco in the composition, more specifically 10 to 25 wt. %, and most specifically 15 to 20 wt. %.

Exemplary fire retardants include mineral oxides, mineral hydroxides, clays, metal oxides, metal hydroxides, and metal carbonates such as magnesite. The fire retardant, when present, can be used in an amount of 5 to 30 wt. % based on the weight of the stucco in the composition, more specifically 10 to 25 wt. %, and most specifically 15 to 20 wt. %.

The gypsum core is normally formed from a slurry or paste (hereinafter referred to as a “slurry” for convenience) comprising stucco and water, together with various solid and liquid additives that regulate the density or uniformity of the mixture, setting time, and other slurry and finished board properties. In an important feature, it has been found advantageous to combine the pregelatinized starch with the stucco dry, i.e., while both are in powder form. It is to be understood that some water is naturally associated even with dry forms of various pregelatinized starches and stucco. It is not necessary to ensure that water is removed from the dry components; rather, the two components are mixed while each is in the form of a powder, rather than a slurry as is conventionally done. Such dry mixing results in an unexpected improvement in the strength of the finished boards as described below. Dry mixing also provides a cost benefit in the manufacturing process. Mixing can occur by a variety of methods, for example a pin mixer.

The dry mixed pregelatinized starch and stucco are then combined with sufficient water to form a slurry. Other solid additives (if present) can be added during the mixing of the pregelatinized starch and the stucco, or can be added to the water, or to the slurry of stucco and starch in water. The slurries used to form the gypsum can have a water demand, or water to stucco ratio of 0.7:1 to 1.1:1, specifically from 0.7:1 to 0.8:1 by weight.

The slurry is then used in the manufacture of gypsum boards. In an exemplary continuous manufacturing process, two reels of facing sheet material (e.g., multi-ply paper) are simultaneously unwound. One reel of a lower facing sheet unwinds below the mixer that forms the slurry, such that the slurry is applied onto this sheet. An upper facing sheet from a second reel is then brought into contact with the slurry from above, thereby sandwiching the slurry. The “sandwich” of slurry and adjacent facing sheets is then passed through a mold or other forming device for establishing the thickness of the gypsum board. The slurry is then allowed to set and form the gypsum core by hydration of the stucco. During this setting process, the core hardens as the gypsum mineral (calcium sulfate dihydrate) is formed.

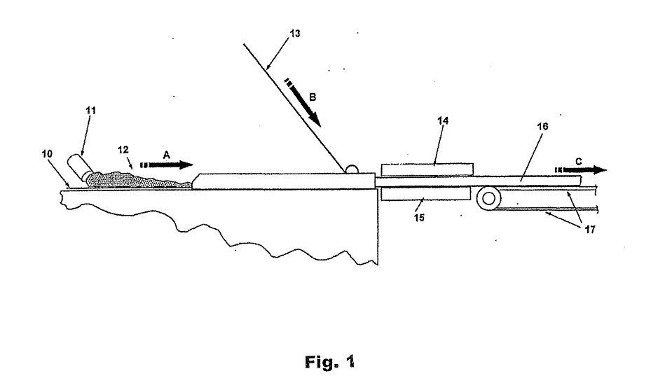

This process for producing gypsum board is illustrated schematically in FIG. 1, which shows a portion of a gypsum board manufacturing line. The dry pregelatinized starch, the stucco, and any other optional dry components from which the slurry is formed are pre-mixed and then fed to a mixer of the type commonly referred to as a pin mixer (not shown). Water and other liquid constituents (e.g., soap or foam, used to control the slurry density), used in forming the slurry, are metered into the pin mixer where they are combined with the dry components to form an aqueous gypsum slurry 12, which emerges from a discharge conduit 11 of the pin mixer. The slurry is deposited through one or more outlets of the discharge conduit 11 onto a continuous, horizontally moving lower facing sheet 10 comprising fibrous material (e.g., multi-ply paper). The amount of slurry deposited can be controlled in manners known in the art. The lower facing sheet 10 is fed from a roll (not shown). Prior to receiving the gypsum slurry 12, the lower facing sheet 10 can be scored by one or more scoring devices, allowing the edges of lower facing sheet 10 to be folded upward. These edges can then be glued to overlapping portions of the upper facing sheet 13 according to methods known in the art.

In practice, this lower facing sheet 10 (and/or an upper facing sheet 13) can be impregnated with a material such as a heat reactive resin (e.g., a B-staged phenolic resin). As explained in more detail hereinafter, if the resin is impregnated predominantly on only one side of the lower facing sheet 10 and/or upper facing sheet 13, then the predominantly resin-impregnated side will face away from the gypsum slurry 12 (i.e., will face downward in the case of the lower facing sheet 10 or upward in the case of the upper facing sheet 13). This generally allows for more effective penetration of the gypsum slurry 12 into at least part of the thickness of the facing sheet(s) 10, 13, for strong, adherent bonding. Partial penetration of the slurry into the facing sheet(s) can be further controlled according to other means, for example by controlling the slurry viscosity.

The lower facing sheet 10 and the deposited gypsum slurry 12 move in the direction of arrow A. The upper facing sheet 13, also comprising fibrous material such as heavy paper, is fed in the direction of arrow B from a roll (not shown) and applied to the upper surface of the gypsum slurry 12. The resulting “sandwich” 16 of gypsum slurry (i.e., the slurry and adjacent facing sheets 10, 13), is pressed to the desired wallboard thickness between plates 14 and 15. Alternatively, the sandwich 16 can be pressed to the desired thickness with rollers or in another manner. The continuous sandwich 16 is then carried by conveyor(s) 17 in the direction of arrow C. The slurry 12 sets and hardens as it is carried along.

The slurry generally contains more water than necessary solely to reconstitute the gypsum from stucco. This extra water is used in the board forming stage to reduce the stucco slurry viscosity sufficiently to allow for its even distribution (e.g., by using a forming roll) across and between the facing sheets at a desired thickness. As a result of the use of excess water, the gypsum board remains wet after hydration (although it is possible at this point the board can be cut to desired dimensions). Therefore, the formed board is ultimately dried.

The drying operation typically involves applying heat by circulating hot air (e.g., in a drying oven) around the wet gypsum board to evaporate the excess water. It is necessary, therefore, that the facing sheets be sufficiently porous to allow this excess water to readily evaporate without adverse effects such as delamination, tearing, bursting, etc. of the facing sheets. The ability of the facing sheets to easily allow the escape of water vapor also promotes a uniform degree of dryness. This improves overall board quality, since insufficiently dried gypsum board presents storage problems, while over-drying leads to calcination and causes a loss of mechanical strength. Typical drying conditions involve maintaining an ambient or surrounding hot air temperature from 200° F. to 600° F. (about 95° C. to 315° C.) specifically from 250° F. to 500° F. (about 120° C. to 260° C.), for a drying time from 10 minutes to 2 hours, specifically from 30 minutes to 1 hour, and with a line speed from 70 to 250 feet/minute, specifically from 100 to 200 feet/minute. These parameters are exemplary and are influenced by the particular configuration of the board manufacturing line.

The facing sheet can comprise any fibrous material known to be suitable for facing gypsum board. Specific materials include paper, such as heavy, single or multi-ply paper (e.g., medium or heavy kraft paper, manila paper, etc.) and cardboard. The use of multi-ply paper can be specifically mentioned for the facing material. Multi-ply paper used for the facing sheet of gypsum board products typically has a basis weight from 50 to 60 pounds per 1000 square feet, an overall caliper of 250 to 350 microns, and a Gurley porosity from 15 seconds to 145 seconds. Often, different types of paper are used for each gypsum board surface. For example, manila paper is frequently used on one side, while newsliner is used on the opposite side. Paper and cardboard facing materials are normally made from recycled fibers (e.g., used corrugated paper, kraft cuttings, or waste newsprint), but they can also be partially or wholly made from virgin fibers. Other natural or synthetic fibrous materials can be used, including those derived from metals or glass (e.g., fiberglass mat, chopped or continuous strand mat, or glass roving, both woven and non-woven). Examples of fibrous non-woven mats are found in U.S. Pat. Nos. 5,772,846 and 4,647,496. Other useful materials for the facing sheet include filament forming synthetic organic polymers (e.g., nylon, polyesters, polypropylene, polyethylene, rayon, and cellulosics), ceramics, cotton, cloth, hair, felt, and the like. Fibrous mats can be bound e.g., with a resin binder. Multiple layers of fibrous materials, for example a composite sheet of a glass mat and kraft paper, can also be used.

Gypsum boards produced using the dry blend described above have excellent aesthetic and mechanical properties, including good strength. For example, in a nail pull resistance test as described below, boards that are up to 91 lbs per msf (1,000 square feet) lighter show higher nail pull resistance and better bonding to the paper face. Boards produced by this method show improved compressive strength as well. It is particularly surprising that these levels of strength can be obtained in the absence of a dispersant such as sodium trimetaphosphate. Dry mixing provides eliminates an entire process step—premixing the starch with water—which provides a cost benefit in manufacturing the gypsum boards.

The above-described composition and methods are further described by examples, which are set forth as representative. They are not to be construed as limiting the scope of the invention as these and other equivalent embodiments will be apparent in view of the present disclosure and appended claims.

The following materials are used in the Examples.

TABLE 1

| Ingredient Type | Name |
|---|---|
| Stucco | Calcium sulfate hemihydrate |
| Pregelatinized starch | Hydroxyethylated corn starch |
| | (Staramic ® 747, Tate and Lyle) |
| Non-pregelatinized | Acid-modified corn starch (LC-211, ADM Milling) |
| starch | |
| Dispersant | Napthalene sulfonate (GS-20, Geo Specialty |
| | Chemicals) |
| Retarder | Versenex ® 80 (Dow Chemical) |
| Soap | Steol ® SA-403 (Stepan Company) |

### EXAMPLE 1

### Weight and Nail Pull Resistance

The formulations in Table 2 were made as follows. The liquid ingredients—water, dispersant, 10% retarder solution, and soap—were mixed in a commercial blender. The solid ingredients—stucco and starch—were mixed separately and added to the liquid ingredients. The slurry was mixed until the vortex closed in on itself.

TABLE 2

| Component | Formulation A | Formulation B |
|---|---|---|
| Stucco (g) | 450 | 450 |
| Pregelatinized Starch (g) | — | 3.47 |
| Non-Pregelatinized Starch (g) | 3.47 | — |
| Dispersant (g) | 3.15 | 3.15 |
| 10% Retarder solution in water (g) | 0.20 | 0.20 |
| Soap (g) | 0.59 | 0.59 |
| Water (g) | 450 | 495 |

A single sheet of gypsum wallboard paper was folded over and taped on the sides in such a manner as to create an “envelope” that fit inside an 11″×10″×½″ (28 cm×25 cm×1.3 cm) vertical mold. The slurry was poured into the gypsum wallboard paper “envelope” and was allowed to set. After setting, Formulation A was taken out of the mold, loosely sealed in aluminum foil, and placed in an oven at 180° C. for 45 minutes, causing the starch to gel. This step was unnecessary for Formulation B, which contained pregelatinized gel. After setting (and the gelation step in the case of Formulation A), the samples were dried to constant weight in a convection oven at 110° F. (43° C.) for 24 hours. After cooling to room temperature in a dessicator, the samples were cut into 4″×4″×½″ (10.2 cm×10.2 cm×1.3 cm) pieces for nail pull resistance testing.

The gypsum board samples were subject to density, nail pull resistance (ASTM C473), and bonding tests in triplicate. As can be seen from TABLE 3, Formulation B, with pregelatinized starch, affords a 91 lb/msf lighter board, a 5 lb higher nail pull resistance, and significantly better bonding to the paper face.

TABLE 3

| | Weight | | | Avg. | | |
|---|---|---|---|---|---|---|
| Starch | of | Board | | Board | Avg. | |
| Name | Sample | Wt. | Nail Pull | Weight | Nail | Bonding |
| and % | Board | (lb/ | Resistance | (lb/ | Pull | to Paper |
| Usage | (g) | msf^{a}) | (lb) | msf^{a}) | (lb) | Face^{b} |
| Formulation | 81.9 | 1623.6 | 76.7 | 1613.7 | 76.3 | 70-80% |
| A | 81.9 | 1623.6 | 80.4 | | | |
| | 80.4 | 1593.8 | 71.9 | | | |
| Formulation | 75.9 | 1504.6 | 78.1 | 1522.5 | 81.1 | 95-100% |
| B | 77.8 | 1542.3 | 85.5 | | | |
| | 76.7 | 1520.5 | 79.9 | | | |

^{a}lb per 1000 sq. ft.
^{b}Area of paper with adhered stucco when paper is pealed from test sample.

### EXAMPLE 2

### Laboratory Cube Compressive Strength Results

The starch type and amount shown in TABLE 4 were dry mixed with stucco, and the mixture added to water and mixed in a commercial blender. The resulting slurries were cast in 2″×2″×2″ (5.1 cm×5.1 cm×5.1 cm) molds, and allowed to set. The cubes were then removed from the molds and dried for 48 hr. in 110° F. (43° C.) oven, and allowed to cool to room temperature in a dessicator. The dry weights and compressive strength of the cubes were measured, and the compressive strength of each cube was normalized to 65 psi.

TABLE 4

| | | | | | Average | | Average^{b} | Std. |
|---|---|---|---|---|---|---|---|---|
| | | Dry wt. | Dry wt. | Strength | Strength | Strength^{b} | Strength | Dev. |
| Starch | Amount^{a} | (g) | (lb/ft³) | (psi) | (psi) | (psi) | (psi) | (psi) |
| LC-211 | 0.54% | 137.8 | 65.6 | 1447 | 1431 | 1433 | 1422 | 32 |
| LC-211 | 0.54% | 137.2 | 65.3 | 1455 | | 1447 | | |
| LC-211 | 0.54% | 137.0 | 65.2 | 1391 | | 1385 | | |
| LC-211 | 0.77% | 138.2 | 65.8 | 1506 | 1502 | 1487 | 1484 | 3 |
| LC-211 | 0.77% | 138.0 | 65.7 | 1500 | | 1483 | | |
| LC-211 | 0.77% | 138.2 | 65.8 | 1500 | | 1481 | | |
| Staramic ® 747 | 0.54% | 138.2 | 65.8 | 1651 | 1680 | 1631 | 1660 | 27 |
| Staramic ® 747 | 0.54% | 138.2 | 65.8 | 1685 | | 1664 | | |
| Staramic ® 747 | 0.54% | 138.2 | 65.8 | 1705 | | 1684 | | |
| Staramic ® 747 | 0.77% | 138.2 | 65.8 | 1656 | 1662 | 1635 | 1642 | 20 |
| Staramic ® 747 | 0.77% | 138.0 | 65.7 | 1644 | | 1626 | | |
| Staramic ® 747 | 0.77% | 138.2 | 65.8 | 1685 | | 1665 | | |

^{a}Percent starch based on stucco wt.
^{b}Normalized to 65 lb/ft³

As can be seen from TABLE 4, the pregelatinized starch formulations afford 238 psi (17%) higher compressive strength at 0.54%, loading and 158 psi (11%) higher compressive strength at 0.77% loading.

All references cited in this specification, including without limitation, all U.S., international, and foreign patents and patent applications, as well as all abstracts and papers (e.g., journal articles, periodicals, etc.), are hereby incorporated by reference into this specification in their entireties. The discussion of the references herein is intended merely to summarize the assertions made by their authors and no admission is made that any reference constitutes prior art. Applicants reserve the right to challenge the accuracy and pertinence of the cited references. In view of the above, it will be seen that several advantages of the invention are achieved and other advantageous results obtained.

As various changes could be made in the above methods and compositions without departing from the scope of the invention, it is intended that all matter contained in this application, including all theoretical mechanisms and/or modes of interaction described above, shall be interpreted as illustrative only and not limiting in any way the scope of the appended claims.

What is claimed is:

1. A composition for the manufacture of a gypsum board, comprising a blend of dry pregelatinized starch and stucco with 0.4 to 3 wt. % of starch, based on the weight of the stucco.

2. The composition of claim 1, wherein the pregelatinized starch is hydroxyalkylated.

3. The composition of claim 1, wherein the pregelatinized starch is hydroxyethylated.

4. The composition of claim 1, wherein the pregelatinized starch is corn starch.

5. The composition of claim 1, wherein the pregelatinized starch is a hydroxyethylated corn starch.

6. The composition of claim 1, comprising 0.5-1 wt. % pregelatinized starch based on the stucco weight.

7. A slurry for the manufacture of a gypsum board, comprising water and the composition of claim 6 with a water to stucco weight ratio of 0.7 to 1.1.

8. The slurry of claim 1, consisting essentially of the hydrated blend of pregelatinized starch and stucco, and a dispersant, foaming agent, set retarder, set accelerators mold and mildew control agent, fillers, water resistance additive, fire retardant, or a combination comprising at least one of the foregoing, wherein no sodium trimetaphosphate is present.

9. The slurry of claim 8, wherein no additional strength-enhancing agent is present.

10. A method for making a gypsum board, the method comprising:
forming a slurry from a dry blend of a pregelatinized starch and stucco;
applying the slurry to lower facing sheet to form a core layer;
applying an upper facing sheet to the upper surface of the gypsum slurry to form a “sandwich” of slurry and lower and upper facing sheets; and
heating the core layer and the upper and lower facing sheets sufficiently to dry the core layer to form the gypsum board.

11. The method of claim 11, wherein the pregelatinized starch is a hydroxyethylated corn starch.

12. The method of claim 11, wherein the slurry consists essentially of the hydrated blend of pregelatinized starch and stucco, and a dispersant, foaming agent, set retarder, set accelerators mold and mildew control agent, fillers, water resistance additive, fire retardant, or a combination comprising at least one of the foregoing, wherein no sodium trimetaphosphate is present.

13. The method of claim 12, wherein no additional strength-enhancing agent is present.

14. The method of claim 10, wherein the upper or lower facing sheet comprises multi-ply paper.

15. The method of claim 10, wherein the drying comprises maintaining a surrounding temperature from 200° F. to 600° F. (95° C. to 315° C.), for a drying time from 10 minutes to 2 hours, and a line speed from 70 to 250 feet/minute.

16. A gypsum board made according to the method of claim 10.

17. A gypsum board comprising a gypsum core that is faced on one or both faces with a facing, wherein the gypsum core comprises the setting product of a slurry of a hydrated blend of 0.4-3 wt. % pregelatinized starch based on the stucco weight.

18. The gypsum board of claim 17, wherein the pregelatinized starch is a hydroxyethylated corn starch.

19. The gypsum board of claim 18, wherein the gypsum core consists essentially of the blend of consists essentially of the blend of pregelatinized starch and stucco, and a dispersant, foaming agent, set retarder, set accelerators mold and mildew control agent, fillers, water resistance additive, fire retardant, or a combination comprising at least one of the foregoing, wherein no sodium trimetaphosphate is present.

20. The gypsum board of claim 19, wherein no additional strength-enhancing agent is present.
